(19) United States
(12) Patent Application Publication
(10) Pub. No.: US 2007/0272453 A1
(43) Pub. Date: Nov. 29, 2007

(54) Power Plant and Driveline for Vehicles

(75) Inventors: James C. LeBlanc SR., Rochester, MI (US); James C. LeBlanc JR., Washington, MI (US)

Correspondence Address: STEVENS DAVIS MILLER & MOSHER, LLP, 1615 L STREET, NW, SUITE 850, WASHINGTON, DC, 20036, US

(73) Assignee: J.C.L. TECHNOLOGY L.L.C., ROCHESTER, MI (US)

(21) Appl. No.: 10/574,540

(22) PCT Filed: Oct. 3, 2003
(86) PCT No.: PCT/US03/31307

§ 371 Date: Feb. 2, 2007

(51) Int. Cl. B62D 61/10

(52) U.S. Cl. 180/24.08

(57) ABSTRACT

A power plant and driveline arrangement for a vehicle having at least two wheel units and a body supported on the wheel units generally consisting of an engine supported on the body; a transmission supported on such body disposed on the underside of the engine; a first transfer case for transferring drive from an output shaft of the engine to an input shaft of the transmission; a second transfer case for transferring drive from an output shaft of the transmission to forwardly and rearwardly projecting output shafts; a first wheel carrier supported on the body forwardly of the second transfer case, having an input shaft drivingly coupled to the forwardly projecting output shaft of the second transfer case, and a pair of laterally projecting half shafts operatively connected to the wheels of the first wheel units; and a second wheel carrier supported on the body rearwardly of the second transfer case, having an input shaft drivingly coupled to the rearwardly projecting output shaft of the second transfer case, and a pair of laterally projecting half shafts operatively connected to the wheels of a second wheel unit.

This application is a §371 application of and claims priority from PCT/US2003/031307, filed Oct. 3, 2003.

This invention relates to a power plant and driveline arrangement for vehicles, and more particularly to such an arrangement providing for all wheel drive.

### BACKGROUND OF THE INVENTION

In the prior art, there has been developed a type of vehicle generally consisting of a set of wheel units, a body of monocoque construction mounted on the wheel units, a power plant and driveline mounted on the body and drivingly connected to the wheel units and a steering system also mounted on the body and operatively connected to one or more of the wheel units. Typically, the power plants of such vehicles have consisted of an engine and transmission arranged in tandem relation within the personnel compartment of the vehicle. Such positioning of the power plant has greatly diminished the useable compartment space of the vehicle, correspondingly restricting the utility of such vehicles. Accordingly, it is the principal object of this invention to provide a vehicle of the type described in which the power plant of the vehicle occupies a minimal amount of the useable personnel compartment of the vehicle. Another object of the invention is to provide such an arrangement which may be easily modified to produce various vehicles having 4×4, 6×6, 8×8, 8×8 extended and 10×10, all wheel drive configurations. A further object is to provide such a power plant and driveline arrangement utilizing a single, commercially available axle carrier which may be easily modified to accommodate each of the wheel units of the vehicle regardless of the wheel configuration or the positions of the wheel units on the vehicle.

### SUMMARY OF THE INVENTION

The aforementioned and other objects of the present invention are achieved by providing a power plant and driveline arrangement for a vehicle having at least two wheel units and a body supported on the wheel units, generally consisting of an engine supported on the body; a transmission supported on the body disposed on the underside of the engine; a first transfer case for transferring drive from an outlet shaft of the engine to an input shaft of the transmission; a second transfer case for transferring drive from the output shaft of the transmission to longitudinally disposed, forwardly and rearwardly projecting output shafts; a first carrier supported on the body forwardly of the second drive transfer case, having an input shaft drivingly coupled to the forwardly projecting output shaft of the second drive transfer case and a pair of transversely projecting half shafts operatively connected to a first set of wheels; and a second carrier supported on the body rearwardly of the second drive transfer case, having an input shaft drivingly coupled to the rearwardly projecting output shaft of the second drive transfer case, and a pair of transversely projecting half shafts operatively connected to a second set of wheels. Preferably, the engine is a diesel engine, a drive motor of a hydraulic system mounted on the body is drivingly connected to the first transfer case, a third drive transfer case operatively interconnects the transmission and the second drive transfer case, which is operable at a first speed, a second speed and at neutral, and the second drive transfer case proportions torque at 30% to the forwardly disposed carrier and 70% to the rearwardly disposed carrier and further provides inter-axle differential drive. In addition, each of such carriers is of a single type, modified depending on its position in the driveline of a 4×4, 6×6, 8×8 or 10×10 wheel configuration.

### BRIEF DESCRIPTION OF THE DRAWINGS

FIG. 1 is a perspective view of a vehicle having a 10×10 wheel configuration, equipped with a power plant and driveline arrangement embodying the present invention;

FIG. 2 is a view similar to the view shown in FIG. 1, illustrating the body and wheel units of the vehicle in phantom lines and the power plant and driveline in solid lines;

FIG. 3 is an enlarged side elevational view of the power plant and driveline arrangement shown in FIG. 2;

FIG. 4 is a top plan view of the arrangement shown in FIG. 3;

FIG. 5 is a vertical cross-section of a carrier utilized in the driveline shown in FIGS. 2-4 which is intended to be positioned rearwardly of a final drive transfer means of the driveline arrangement, transfer drive to a set of wheels and further transfer drive therethrough;

FIG. 6 is a view similar to the view shown in FIG. 5, illustrating a carrier similar to the carrier shown in FIG. 5 but reoriented 180°, and adapted to be positioned forwardly of a final drive transfer means, transfer drive to a set of wheels and transfer drive therethrough to another carrier;

FIG. 7 is a view similar to the view shown in FIG. 6, illustrating a carrier modified relative to the carrier shown in FIG. 6, which is adapted to be positioned in a driveline forwardly of a type of carrier as shown in FIG. 6 and transfer drive to a set of wheels;

FIG. 8 is a view similar to the view shown in FIG. 5, illustrating a modification of the carrier shown in FIG. 5, which is adapted to be positioned in a driveline rearwardly of the type of carrier shown in FIG. 5 and transfer drive to a set of wheels;

FIG. 9 is a view similar to the view shown in FIG. 3, having one less carrier to accommodate a vehicle having an 8×8 wheel configuration;

FIG. 10 is top plan view of the arrangement shown in FIG. 9;

FIG. 11 is a view similar to the view shown in FIG. 9, having a modified 8×8 wheel configuration to accommodate an extended vehicle;

FIG. 12, is a top plan view of the arrangement shown in FIG. 11;

FIG. 13 is a side elevational view similar to the view shown in FIG. 9, illustrating an arrangement having one less carrier to accommodate a vehicle having a 6×6 wheel configuration;

FIG. 14 is a top plan view of the arrangement shown in FIG. 13;

FIG. 15 is a view similar to the view shown in FIG. 11, illustrating an arrangement having one less carrier to accommodate a vehicle having a 4×4 wheel configuration; and

FIG. 16 is a top plan view of the arrangement shown in FIG. 13.

### DESCRIPTIONS OF PREFERRED EMBODIMENTS OF THE INVENTION

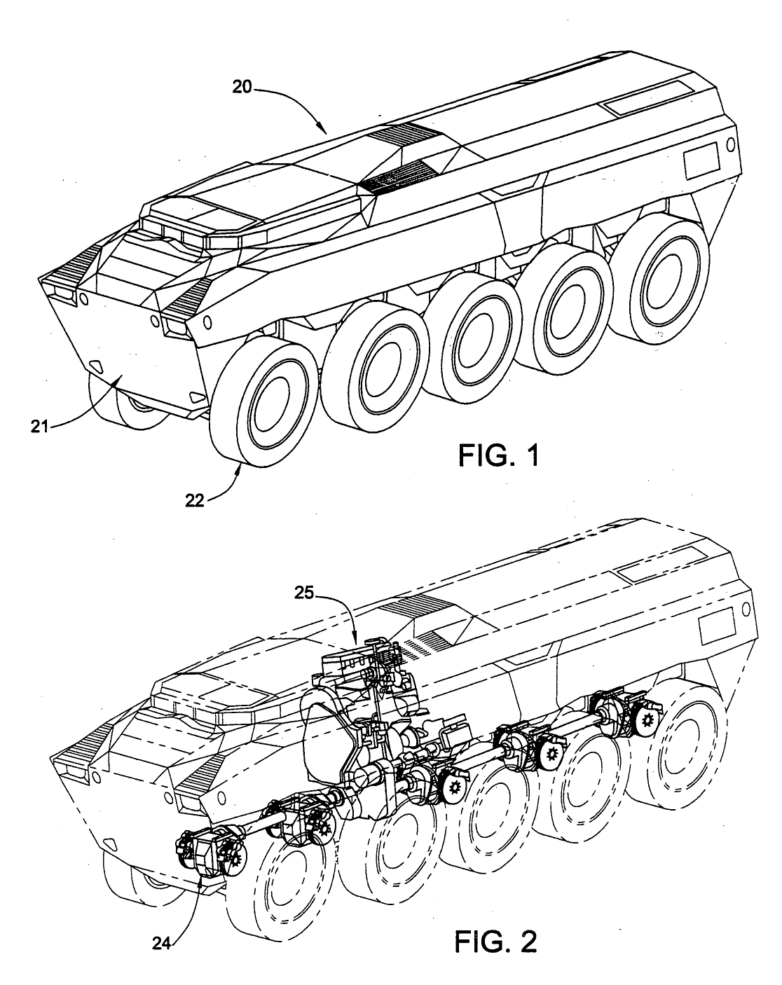

Referring to FIGS. 1 through 8 of the drawings, there is provided an automotive vehicle 20 generally consisting of a monocoque body or hull 21 mounted on a set of wheel units 22, a power plant 23 mounted within the body, a driveline 24 for transmitting drive from the power plant to the wheel units, a steering system mounted on the body and operatively connected to the steerable wheel units and various other auxiliary equipment and systems. The wheel units are of a type as illustrated and described in that certain PCT Application entitled Wheel Unit for Automotive Vehicles, filed on the same date hereof, which is incorporated herein by reference, and the steering system is of the type as illustrated and described in that certain PCT Patent Application entitled Steering System for Vehicles, also filed on the same date hereof, which also is incorporated herein by reference. The underside of the hull is provided with five longitudinally spaced, transversely disposed recesses each opening into wheel wells to accommodate five wheel units and thus provide a vehicle with a 10×10 wheel configuration.

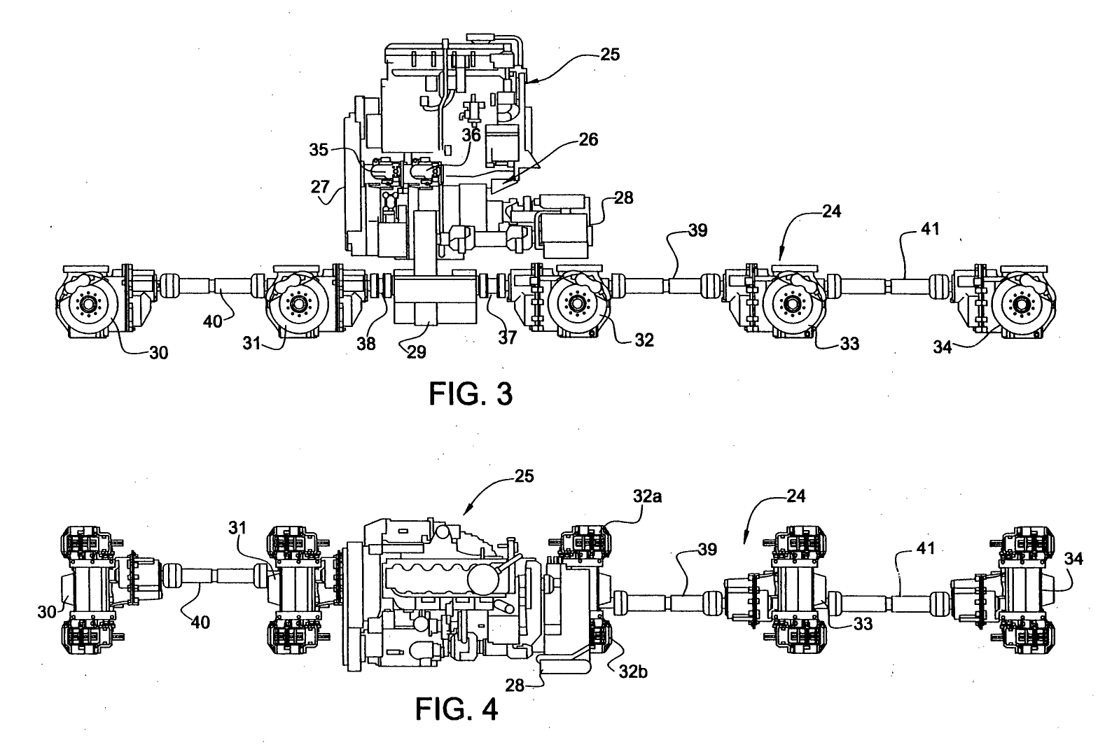

As best shown in FIGS. 3 and 4, the power plant and driveline arrangement includes an engine 25, a transmission 26, drive transfer cases 27 through 29 and a set of axle carriers 30 through 34. Engine 25 preferably is a diesel engine having sufficient horsepower to drive the vehicle, its systems and its complement. The engine is mounted in the hull of the vehicle and disposed essentially between the second and third axle positions. In certain applications, it further may consist of a gas engine, a turbine engine or a Wankel engine. Transmission 26 also is mounted within the hull of the vehicle, directly beneath the engine. Drive from the engine to the transmission is provided by transfer case 27 which essentially consists of a gear train interconnecting the output shaft of the engine to the input shaft of the transmission. Operatively connected to such gear train is a set of hydraulic motors 35 and 36 used to operate various hydraulic systems on the vehicle and lubricate various operating components including the transfer cases. Drive transfer case 28 transfers drive from transmission 26 to drive transfer case 29. It also consists of a gear train operatively interconnecting the output shaft of the transmission with the input shaft of drive transfer case 29. It further includes a gear train with means operable to transmit first and second ranges and be disconnected to allow the engine to idle in neutral. Drive transfer case 29 similarly consists of a gear train operatively interconnecting an input shaft and a pair of longitudinally disposed output shafts. Transfer cases 27, 28 and 29 also are disposed within the interior of the hull with transfer case 29 being disposed at a lower end of the hull between the second and third axle positions. Transfer case 29 also includes a parking brake.

Axle carriers 30 through 34 are disposed on the exterior underside of the vehicle within the transverse recesses in the hull defining axle positions 1 through 5, and are secured to and depend from transversely disposed panels of the hull by bolts or other suitable means. Carrier 32 disposed in the third axle position rearwardly of transfer case 29, has an input shaft drivingly connected to transfer case 29 by means of a short shaft 37. Carrier 31 is disposed immediately forwardly of transfer case 29, in the second wheel position, and is provided with an input shaft 38 drivingly connected to an output shaft of transfer case 29. Because of the limited spaces between transfer case 29 and carriers 31 and 32, drive shafts 37 and 38 are connected to transfer case 29 and carriers 31 and 32 by gear couplings. Carrier 33 is disposed rearwardly of carrier 32, in the fourth axle position, and is drivingly connected to carrier 32 by means of a drive shaft 39 drivingly interconnecting the output shaft of carrier 32 with the input shaft of carrier 33. Carrier 30 is disposed forwardly of carrier 31, in the first axle position, and is drivingly connected to carrier 31 by means of a drive shaft 40 axially aligned with drive shaft 38. Carrier 34 is disposed rearwardly of carrier 33, in the fifth axle position, and is drivingly connected to carrier 33 by means of a drive shaft 41 which is axially aligned with drive shafts 37 and 39.

Transfer case 29 includes means for providing inter-axle differential drive. Carriers 31, 32 and 33 also include gearing arrangements providing for inter-axle differential drive. All of the carriers include means for providing inter-wheel differential drive. Each of the carriers is provided with transversely projecting half shafts drivingly connected to the wheels of an associated wheel unit and further is provided with a set of disc brake assemblies as at 32a and 32b.

Carrier 32 is of a commercially available type manufactured by the Spicer Heavy Axle and Brake Division of the Dana Corporation situated in Kalamazoo, Mich., U.S.A., providing inter-axle and inter-wheel differential drive. Carrier 33 is similar in construction and function to carrier 32, also providing inter-axle and inter-wheel differential drive. Carrier 34 is a modification of carrier 32, providing only inter-wheel differential drive. Carrier 31 is identical to carrier 32 although reoriented or angularly displaced 180° about vertical axes relative to carrier 32, providing both inter-axle and inter-wheel differential drive. Carrier 30 is identical in construction and function to carrier 34 but reoriented or angularly displaced 180° about vertical axes relative to carrier 34, providing only inter-wheel differential drive. In essence, carriers 30 and 31 are comparable to carriers 34 and 32, respectively, but driven in reverse directions as carriers 34 and 32 would be driven if driven in reverse.

In addition to providing inter-axle differential drive, drive transfer case 29 includes a suitable arrangement to proportion torque at 30% to forwardly disposed carriers 31 and 30 and at 70% to rearwardly disposed carriers 32, 33 and 34. It further may be locked to proportion torque 50/50.

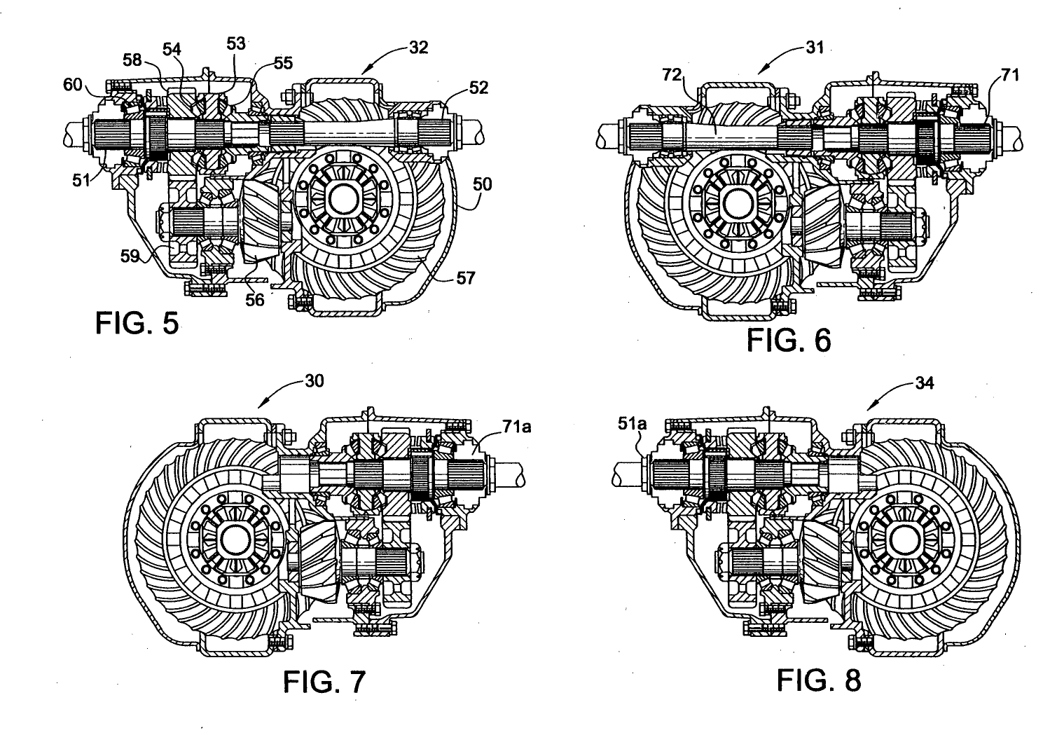

FIG. 5 illustrates in more detail the components of carrier 32 which include a housing 50, an input shaft 51, an output shaft 52, a planetary gear including a spider 53, a set of planetary gears 54 and a sun gear 55, a hypoid bevel gearset including a beveled pinion 56 and a crown wheel 57 and a pair of gears 58 and 59. Sun gear 55 is provided with a tubular shaft which is journaled in a tapered roller bearing mounted on the housing. Input shaft 51 has an end mounted in a bearing provided on the housing, and an end received within the tubular shaft portion of sun gear 55 for free rotation therein. Output shaft 52 is coaxially aligned with input shaft 51 and has an inner end received within and splined to the tubular shaft portion of sun gear 55, and an outer end journaled in a set of tapered roller bearings supported on the carrier housing. Beveled pinion 56 is provided with a shaft portion journaled in a set of tapered roller bearings supported on the carrier housing, and meshes with crown wheel 57. The axis of crown wheel 57 is offset relative to the axis of pinion 56 which is characteristic of such gearsets. Gear 58 is mounted on input shaft 51 and is free to rotate thereon. Gear 59 is splined to the shaft portion of beveled gear 56 and further meshes with gear 58. Gear 58 is further provided with a set of teeth meshing with the planet gears of the planetary gear assembly. Sun gear 55 similarly is provided with a set of teeth which also mesh with the planetary gears of planetary gear assembly 53. Drive transmitted to input shaft 51 rotates the spider which functions to transmit differential drive to gear 58, and to sun gear 55 and output shaft 52. Drive from gear 58 is transmitted to crown wheel 57 through gear 59 and beveled pinion 56.

Mounted coaxially with respect to crown wheel 57 is a differential gear arrangement operatively connected to crown wheel 57 to provide inter-wheel differential drive to the laterally projecting output shafts of carrier 32. It will be appreciated that the planetary gear arrangement 53 provides differential drive between input shaft 51 and output shaft 52, and the differential gear arrangement operatively connected to crown gear 57 provides differential drive between operatively connected half shafts. Inter-axle differential drive may be locked out by a sliding dog clutch 60 which may be displaced axially relative to the input shaft to lock the input and output shafts together. Similar clutch means is provided for locking the drive to the half shafts connected to the carrier. The differentials, however, may be of a locking or unlocking type. The housings of disc brake assemblies 32a and 32b are mounted on the sides of carrier housing 50 and are operatively connected to the half shafts to provide a braking action in the conventional manner.

Carrier 33 is identical to carrier 32 and similarly functions to provide inter-axle differential drive and inter-wheel differential drive.

Carrier 31 shown in detail in FIG. 6 is identical to carrier 32 but reoriented or angularly displaced 180° about a vertical axis relative thereto. It includes an input shaft 71 comparable to input shaft 51 and an axially aligned output shaft 72 comparable to output shaft 52. It essentially is driven in reverse relative to carrier 32 and similarly functions to provide inter-axle differential drive and inter-wheel differential drive in the same manner as carrier 32. It also is provided with brake disc assemblies mounted on the sides of the housing thereof and operatively connected to a pair of half shafts.

Carrier 34 shown in detail in FIG. 8 is identical to carrier 32 with the exception of the omission of an output shaft comparable to output shaft 52 in carrier 32. Such carrier functions merely to transfer inter-wheel differential drive. It is essentially a modification of carrier 32 with the output shaft thereof removed.

Carrier 30 shown in detail in FIG. 7 is similar to and a modification of carrier 31 in that an output shaft comparable to output shaft 72 in carrier 31 is omitted. Similar to carrier 34, it merely functions to transfer inter-wheel differential drive to the half shafts operatively connected thereto. It also is provided with a pair of disc brake assemblies mounted on the sides of the housing thereof and operatively connected to an associated pair of half shafts. With respect to carriers 30 and 31 which essentially are commercially available carriers that may be modified and reoriented to run in their essentially reverse condition, the mating teeth of the hypoid bevel gearsets are provided with reverse grinds.

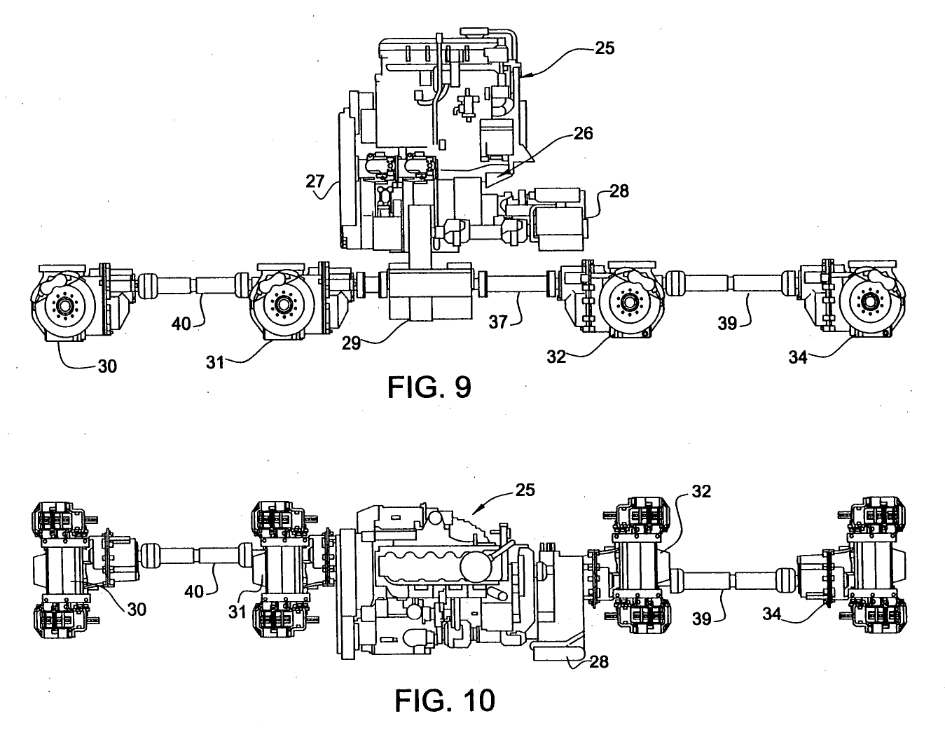

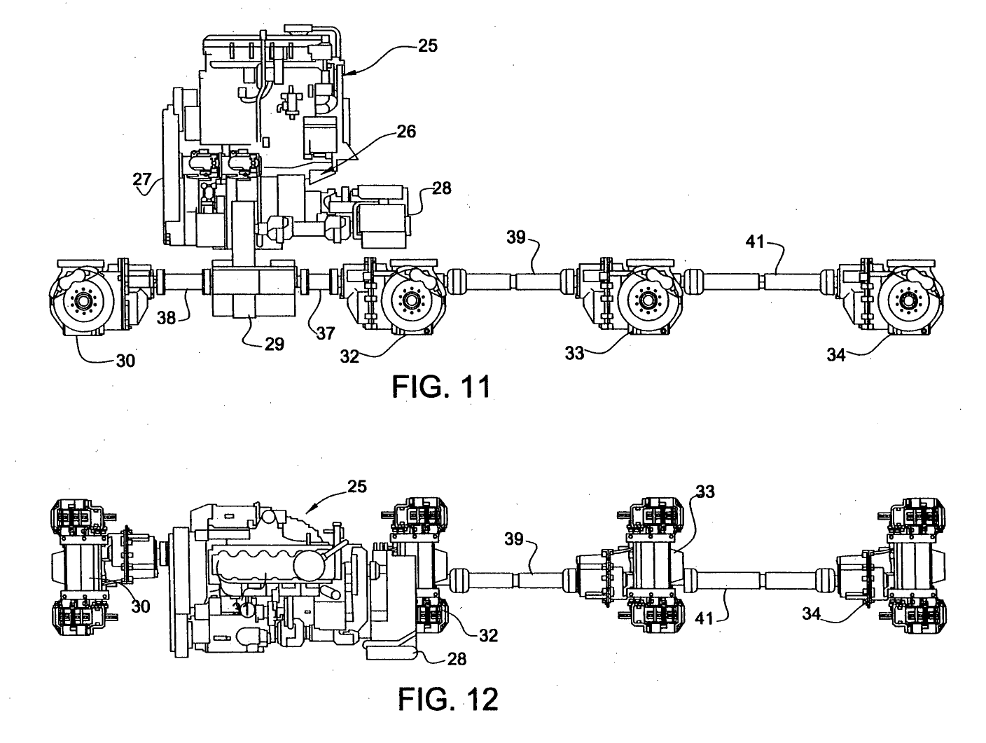

The power plant and driveline arrangement shown in FIGS. 3 and 4 may easily be modified to accommodate a vehicle having an 8×8 wheel configuration simply by eliminating carrier 33 and drive shaft 41 and coupling carrier 34 to drive shaft 39 to provide the configuration as shown in FIGS. 9 and 10. In such arrangement, carriers 30, 31, 32 and 34 would be disposed in wheel positions 1 through 4, respectively, and the power plant would be positioned between the second and third axle positions. Alternatively, the arrangement shown in FIGS. 3 and 4 may be modified to accommodate an extended vehicle having an 8×8 wheel configuration by eliminating carrier 31 and drive shaft 40 and coupling carrier 30 to drive shaft 38 to provide the configuration as shown in FIGS. 11 and 12. In such alternate arrangement, carriers 30, 32, 33 and 34 would be disposed in wheel portions I through 4, respectively, and the power plant would be positioned between the first and second axle positions.

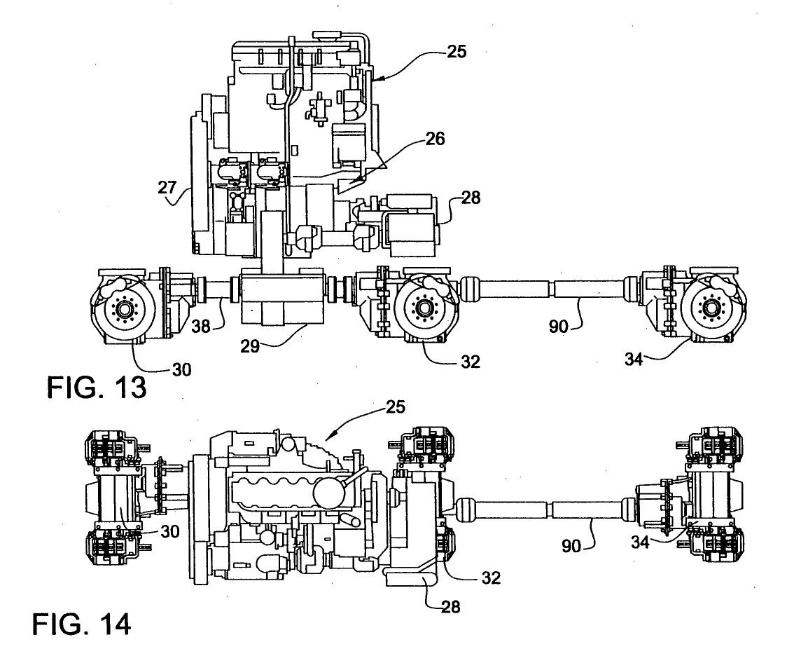

To further modify the arrangement shown in FIGS. 3 and 4 to accommodate a vehicle having a 6×6 wheel configuration, carrier 33 and drive shaft 41 would be omitted, drive shaft 39 would be replaced by a longer shaft 90 and carrier 34 would be coupled to such longer shaft 90, and carrier 31 and drive shaft 40 would be omitted and carrier 30 would be coupled to transfer case 29 by means of drive shaft 38 to arrive at the configuration shown in FIGS. 13 and 14. In such arrangement, carriers 30, 32 and 34 would be disposed in first, second and third axle positions, respectively, and the power plant would be mounted on the vehicle between the first and second axle positions.

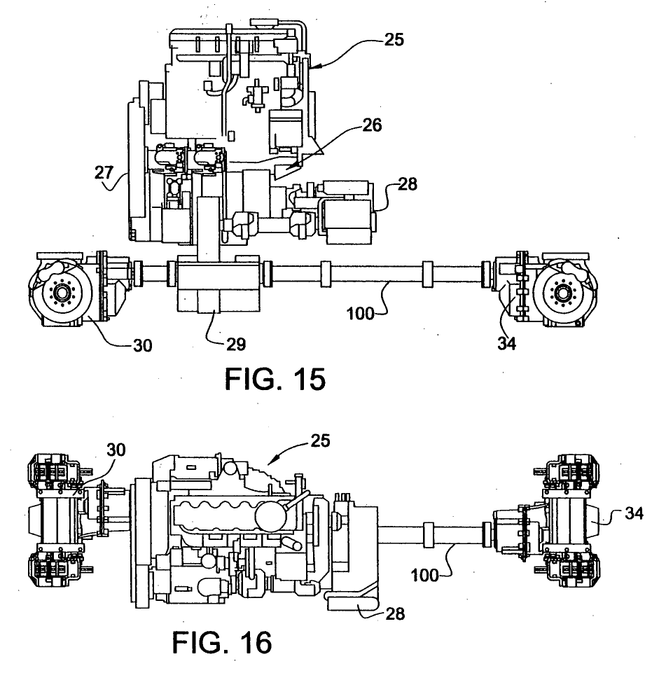

To still further modify the arrangement shown in FIGS. 3 and 4 to accommodate a vehicle having a 4×4 configuration, carriers 32 and 33 and drive shafts 39 and 41 would be omitted, a longer drive shaft 100 would be provided drivingly interconnecting transfer case 29 and carrier 34, and carrier 31 and drive shaft 40 would be omitted and carrier 30 would be coupled directly to transfer case 29 to provide a configuration as shown in FIGS. 15 and 16. In such arrangement, carriers 30 and 34 would be disposed in axle positions 1 and 2 and the power plant would be positioned between them.

The arrangement as described provides a number of substantial benefits and advantages. By stacking the engine and transmission in the interior of the vehicle hull, the floor to roof area within the personnel and equipment compartment of the vehicle is greatly increased. The use of a commercially available axle carrier which can be easily modified to be used in a variety of wheel configurations substantially reduces the cost of the vehicle and particularly a family of vehicles having different wheel configurations. The enclosure of the power plant, drive transfer cases and the drive shaft couplings protects such components from the deleterious effects of the weather and other exposures. Finally, the arrangement provides for easily modifying the arrangement to provide a variety of wheel configurations including 4×4, 6×6, 8×8, 8×8 extended and 10×10 wheel configurations. In addition, such an arrangement is able to accommodate wheel units and a steering system as illustrated and described in the aforementioned applications, provides all wheel drive and further provides both inter-axle and inter-wheel differential drives.

From the foregoing detailed description, it will be evident that there are a number of changes, adaptations and modifications of the present invention that come within the province of those having ordinary skill in the art to which the present invention pertains. However, it is intended that all such variations not departing from the spirit of the invention be considered as within the scope thereof as limited solely by the following claims.

1. A power plant and driveline arrangement for a vehicle having at least two wheel units and a body supported on said wheel units comprising: an engine supported on said body; a transmission supported on said body disposed on the underside of said engine; a first means for transferring drive from an output shaft of said engine to an input shaft of said transmission; a second means for transferring drive from an output shaft of said transmission to forwardly and rearwardly projecting output shafts; a first wheel carrier supported on said body forwardly of said second drive transferring means, having an input shaft drivingly coupled to said forwardly projecting output shaft of said second drive transferring means, and a pair of laterally projecting half shafts operatively connected to the wheels of a first wheel unit; and a second wheel carrier supported on said body rearwardly of said second drive transferring means, having an input shaft drivingly coupled to said rearwardly projecting output shaft of said second drive transferring means, and a pair of laterally projecting half shafts operatively connected to the wheels of a second wheel unit.

2. An arrangement according to claim 1 including a third means for transferring drive operatively interconnecting said transmission output shaft and said second means for transferring drive, selectively operable to transmit a first drive, a second drive or no drive.

3. An arrangement according to claim 1 including a pair of longitudinally disposed drive shafts, one operatively interconnecting an output shaft of said second drive transferring means and said input shaft of said first carrier, and the other one operatively interconnecting an output shaft of said second drive transferring means and said input shaft of said second carrier.

4. An arrangement according to claim 1 including a hydraulic system for operating selected systems on said vehicle, having a motor drivingly connected to said first drive transferring means.

5. An arrangement according to claim 1 wherein said engine comprises a diesel engine.

6. An arrangement according to claim 1 wherein said engine comprises a turbine engine.

7. (canceled)

8. (canceled)

9. (canceled)

10. An arrangement according to claim 1 wherein said second drive transferring means is operative to proportion transmitted torque, 30% to said first carrier and 70% to said second carrier.

11. An arrangement according to claim 1 wherein said second drive transferring means is operable selectively to provide differential drive between said first and second carrier and to lock to evenly provide drive to said first and second carriers.

12. An arrangement according to claim 1 wherein said second drive transferring means is operable to provide differential drive between said first and second carriers.

13. An arrangement according to claim 3 wherein said second drive transferring means is operable to provide inter-axle differential drive.

14. An arrangement according to claim 1 wherein said couplings of said shafts comprise gear couplings.

15. An arrangement according to claim 3 wherein said couplings of said drive shafts comprise gear couplings.

16. An arrangement according to claim 1 including a selectively operable brake operatively connected to said second drive transferring means.

17. (canceled)

18. (canceled)

19. An arrangement according to claim 1 wherein each of said carriers is provided with an inter-wheel differential.

20. (canceled)

21. An arrangement according to claim 1 including a pair of disc brake assemblies mounted on each of said carriers, and wherein each of said assemblies is operatively connected to a half shaft.

22. (canceled)

23. (canceled)

24. A power plant and driveline arrangement for a vehicle having at least two wheel units and a body supported on said wheel units, comprising: an engine supported on said body; a transmission supported on said body, disposed on the underside of said engine; a first means for transferring drive from an output shaft of said engine to an input shaft of said transmission; a second means for transferring drive from an output shaft of said transmission to forwardly and rearwardly projecting output shafts; a first carrier supported on said body forwardly of said second drive transferring means, having an input shaft drivingly connected to said forwardly projecting shaft of said second drive transferring means and a pair of laterally projecting half shafts operatively connected to a set of wheels of a wheel unit; a second carrier supported on said body rearwardly of said second drive transferring means, having an input shaft drivingly coupled to said rearwardly projecting output shaft of said second drive transferring means, and a pair of laterally projecting half shafts operatively connected to a set of wheels of a wheel unit; and a third carrier supported on said body rearwardly of said second carrier, having an input shaft drivingly coupled to an output shaft of said second carrier, and pair of laterally projecting half shaft operatively connected to a set of wheels of a wheel unit.

25. (canceled)

26. An arrangement according to claim 24 including a set of longitudinally disposed drive shafts, one operatively interconnecting an output shaft of said second drive transferring means and said input shaft of said first carrier, one operatively interconnecting an output shaft of said second drive transferring means and said input shaft of said second carrier and one operatively interconnecting an output shaft of said second carrier and an input shaft of said third carrier.

27. (canceled)

28. (canceled)

29. (canceled)

30. (canceled)

31. (canceled)

32. (canceled)

33. (canceled)

34. (canceled)

35. A power plant and driveline arrangement for a vehicle having at least two wheel units and a body supported on said wheel units, comprising: an engine supported on said body; a transmission supported on said body, disposed on the underside of said engine; a first means for transferring drive from an output shaft of said engine to an input shaft of said transmission; a second means for transferring drive from an output shaft of said transmission to forwardly and rearwardly projecting output shafts; a first carrier supported on said body forwardly of said second drive transferring means, having an input shaft drivingly connected to said forwardly projecting shaft of said second drive transferring means and a pair of laterally projecting half shafts operatively connected to the wheels of a wheel unit; a second carrier supported on said body rearwardly of said second drive transferring means, having an input shaft drivingly coupled to said rearwardly projecting output shaft of said second drive transferring means, and a pair of laterally projecting half shafts operatively connected to wheels of a wheel unit; a third carrier supported on said body rearwardly of said second carrier, having an input shaft drivingly coupled to an output shaft of said second carrier and a pair of laterally projecting half shafts operatively connected to wheels of a wheel unit; and a fourth carrier supported on said body forwardly of said first carrier, having an input shaft drivingly coupled to an output shaft of said first carrier, and a pair of laterally projecting half shafts operatively connected to wheels of a wheel unit.

36. An arrangement according to claim 35 including a third means for transferring drive operatively interconnecting said transmission output shaft and said second means for transferring drive, selectively operable to transmit drive at a first speed, transmit drive at a second speed and transmit no drive in a neutral position.

37. (canceled)

38. (canceled)

39. (canceled)

40. (canceled)

41. (canceled)

42. (canceled)

43. (canceled)

44. (canceled)

45. (canceled)

46. A power plant and driveline arrangement for a vehicle having at least two wheel units and a body supported on said wheel units comprising: an engine supported on said body; a transmission supported on said body, disposed on the underside of said engine; a first means for transferring drive from an output shaft of said engine to an input shaft of said transmission; second means for transferring drive from an output shaft of said transmission to forwardly and rearwardly projecting output shafts; a first carrier supported on said body forwardly of said second drive transferring means, having an input shaft drivingly connected to said forwardly projecting shaft of said second drive transferring means and a pair of laterally projecting half shafts operatively connected to the wheel of a wheel unit; a second carrier supported on said body rearwardly of said second drive transmitting means, having an input shaft drivingly coupled to rearwardly projecting output shaft of said second drive transferring means, and a pair of laterally projecting half shafts operatively connected to wheels of said wheel unit; a third carrier supported on said body rearwardly of said second carrier, having an input shaft drivingly coupled to an output shaft of said second carrier and a pair of laterally projecting half shafts operatively connected to wheels of a wheel unit; and a fourth carrier supported on said body rearwardly of said third carrier, having an input shaft drivingly coupled to an output shaft of said third carrier and a pair of laterally projecting half shafts operatively connected to wheels of a wheel unit.

47. A power plant and driveline arrangement for a vehicle having at least two wheel units and a body supported on said wheel units comprising: an engine supported on said body; a transmission supported on said body disposed on the underside of said engine; a first means for transferring drive from an output shaft of said engine to an input shaft of said transmission; a second means for transferring drive from an output shaft of said transmission to forwardly and rearwardly projecting output shafts; a first carrier supported on said body forwardly of said second drive transferring means, having an input shaft drivingly connected to said forwardly projecting shaft of said second drive transferring means, and a pair of laterally projecting half shafts operatively connected to the wheels of a first wheel unit; a second wheel carrier supported on said body rearwardly of said second drive transferring means, having an input shaft drivingly coupled to said rearwardly projecting output shaft of said second drive transferring means, and a pair of laterally projecting half shafts operatively connected to a set of wheels of a wheel unit; a third carrier supported on said body rearwardly of said second carrier, having an input shaft drivingly coupled to an output shaft of said second carrier, and a pair of laterally projecting half shafts operatively connected to a set of wheels of a wheel unit; a fourth carrier supported on said body forwardly of said first carrier, having an input shaft drivingly coupled to an output shaft of said first carrier, and a pair of laterally projecting half shafts operatively connected to a set of wheels of a wheel unit; and a fifth carrier supported on said body rearwardly of said third carrier, having an input shaft drivingly coupled to an output shaft of said third carrier and a pair of laterally projecting half shafts operatively connected to a set of wheels of a wheel unit.

48. An arrangement according to claim 47 including a third drive transferring means operatively interconnecting said output shaft of said transmission and said second means for transferring drive, selectively operable to transmit drive at a first speed, transfer drive at a second speed and not transfer drive in a neutral condition.

49. (canceled)

50. (canceled)

51. (canceled)

52. (canceled)

53. (canceled)

54. (canceled)

55. (canceled)

56. (canceled)

57. (canceled)
